(19) United States
(12) Patent Application Publication
(10) Pub. No.: US 2010/0105487 A1
(43) Pub. Date: Apr. 29, 2010

(54) SEALED DEVICE FOR TRANSMITTING A ROTATIONAL MOVEMENT INSIDE A CHAMBER

(75) Inventors: Guy Delaisse, Auxerre (FR); Fabrice Bariau, Auxerre (FR)

Correspondence Address: HARNESS, DICKEY & PIERCE, P.L.C., P.O. BOX 828, BLOOMFIELD HILLS, MI, 48303, US

(73) Assignee: Mouvex, Auxerre (FR)

(21) Appl. No.: 12/527,617

(22) PCT Filed: Feb. 18, 2008
(86) PCT No.: PCT/FR08/00182

§ 371 Date: Nov. 11, 2009

(30) Foreign Application Priority Data
Feb. 19, 2007 (FR) 0753340

(51) Int. Cl. F16D 3/64; B23P 11/00

(52) U.S. Cl. 464/79; 29/428

(57) ABSTRACT

The application relates to a sealed device for transmitting a rotational movement inside a chamber from a drive shaft to a driven shaft, said drive shaft including at least one input section extending through a wall of the chamber and supported by two bearings, one of which is located inside the sealed casing very close to the output section, and intended to co-operate with a rotational drive means, and an output section engaged with the driven shaft and inclined by an angle a in relation to the input section. The device includes a sealed casing surrounding the portion of drive shaft located in the chamber. The sealed casing includes at least: a bellows portion conferring flexibility on the casing at the intersection between the axis of the input section and the axis of the output section of the drive shaft; and a rigid sleeve extending alongside the bellows portion in the direction of the end of the output section of the drive shaft. The application also relates to a method for producing a sealed transmission device.

### CROSS-REFERENCE TO RELATED APPLICATIONS

This application is a National Phase Entry of International Application No. PCT/FR2008/000182, filed on Feb. 13, 2008 which claims priority to French Patent Application No. 0753340, filed on Feb. 19, 2007, both of which are incorporated by reference herein.

### BACKGROUND AND SUMMARY

The invention more particularly relates to a device making it possible to transmit the rotational movement to a pump shaft.

In the prior art, sealed devices for transmitting a rotational movement inside a chamber are known. Such devices are more particularly disclosed in the French application for a patent FR 2 746 452 in the name of the applicant.

The device described in the present document includes a drive shaft including an input section extending through a wall of the flow space of a pump and cooperating with a rotational driving means, and a section inclined in relation to the input section, the end of which is engaged with a driven shaft so as to transmit the rotational movement. In order to provide the sealing between the inside and the outside of the flow space, the portion of the drive shaft positioned in the flow space is surrounded with a non rotating sealed sleeve including two metallic bellows. The bellows are mounted to slide on the inclined section so as to provide a sufficient service life.

However, this type of device has disadvantages. As a matter of fact, the maximum excentration of the end of the section inclined in relation to the output section is limited since the exceeding of such maximum excentration leads to the buckling of the bellows. As a matter of fact, in order to limit the constraints generated in the bellows plies resulting from the deformation of the plies, the inclination angle a between the input section and the output section must be limited. Thus, in order to increase the excentration, the length of the inclined section and thus of the bellows must be increased. Now, the increase of the length of the bellows through the addition of several plies reduces the rigidity of the bellows and even makes it unstable in its movements. This instability can be called the buckling of the bellows. Thus, because of this impossibility to increase the excentration under the threat of causing the buckling of the bellows, the effort required for driving into rotation the driven shaft is relatively high.

The invention aims at remedying these problems by providing a device for transmitting a rotational movement which is sealed, resistant and enables to reduce the effort required for actuating the driven shaft by increasing the lever arm thereof. For this purpose and according to a first aspect, the invention provides a sealed device for transmitting the rotational movement including:

a chamber inside which the movement is transmitted

a driven shaft;

a drive shaft including at least an input section extending through a wall of said chamber and intended to cooperate with a rotational drive means and an output section engaged with the driven shaft and inclined by an angle a in relation to said input section; the device including a non rotating sealed casing surrounding the drive shaft inside said chamber.

The sealed casing includes at least:

a bellows portion conferring flexibility on the casing at the intersection between the axis of the input section and the axis of the output section of the drive shaft, and

a rigid sleeve extending alongside the bellows portion in the direction of the end of the output section of the drive shaft.

Thus, according to the invention, the sealed casing is stable since the portion of the bellows uses a restrictive number of juxtaposed annular elements. In addition, the excentration of the end of the inclined portion can be increased proportionally to the length of the rigid sleeve since this portion of the casing does not affect the rigidity of the casing. Thus, the effort required for the rotation of the driven shaft is reduced through the increase of the lever arm.

Advantageously, the bellows portion extends by an equal distance on either side of said intersection so as to draw an arc of circle. Thus, the constraints are equally distributed on each ply. Preferably, in order to obtain an important excentration, the length of the rigid sleeve is greater than half the length of the bellows portion.

In addition, in the devices of the prior art, the bellows casing undergo deformations resulting from the difference in pressure between the inside of the casing and the chamber. As a matter of fact, a bellows, the axis of which draws an arc of circle will change shape when pressurised. Under such circumstances, the shape taken by the bellows depends on the direction of the pressure discrepancy. If the pressure inside the bellows is greater than that inside the chamber then said bellows will bend. On the contrary, if the pressure in the bellows is smaller than the pressure in the chamber, then the bellows will be bent upwards. The consequence of such deformations is an increase in the constraints in some plies of the bellows which result in a reduction in the service life of said bellows.

Advantageously, to solve the above-mentioned problem, the sealed casing is filled with a liquid in order to balance the pressure between the inside of the chamber and the inside of the casing. The filling of the internal volume of the flexible and sealed cavity with a liquid is an efficient solution to solve the above-mentioned problem. In a preferred embodiment, the liquid is a degassed lubricant. The degassed lubricant is advantageous in that it can, on the one hand and at our level, be considered as non compressible and on the other hand and at our level, be considered as insensitive to vacuum within the limit of the vapour pressure thereof.

Advantageously, the sealed casing is on the one hand fixed to the chamber and on the other hand mounted on the drive shaft through a sliding bearing. The sealed casing thus has a degree of axial freedom at one of its ends. Then, the casing is adapted for undergoing expansions or contractions of the liquid as a function of the evolution of temperature inside the chamber.

Advantageously, the drive shaft is mounted to rotate through a bearing mounted on a support extending inside said chamber. Thus, the bearing of the drive shaft is close to the point of transmission of the torque, which makes it possible to reduce the efforts applied on said bearing. Advantageously, the output section of the drive shaft is fixed to the input section through a supporting flange. Thus, the length of the input section is increased and the supporting bearing of the drive shaft can be positioned closer to the point of transmission of the torque.

In one embodiment, the device includes a connection part positioned at the end of the drive shaft, the driven shaft being provided with a cradle for receiving said connection part. Advantageously, the sealed casing is made of a stainless metallic material or a composite material. Thus, the material of the casing is chemically compatible with all kinds of liquid pumped and resists a utilisation at high temperatures.

According to a second aspect, the invention relates to a method for manufacturing a sealed transmission device according to the first aspect of the invention including a step of filling the sealed casing with a liquid in order to balance the pressure between the chamber and the inside of the casing. Preferably, said method further includes a step prior to the filling step consisting in putting said sealed casing under a vacuum.

### BRIEF DESCRIPTION OF DRAWINGS

Other objects and advantages of the invention will appear while reading the following description and referring to the appended drawings, wherein:

FIG. 1 is a schematic representation of the device for transmitting a rotation from a drive shaft to a driven shaft according to the invention;

FIG. 2 schematically illustrates the connection between the drive shaft and the driven shaft;

FIG. 3 is a sectional view of a device for transmitting the movement according to a particular embodiment of the invention;

FIG. 4 shows the drive shaft of the transmitting device of FIG. 3;

FIG. 5 is a view of the device of FIG. 3 illustrating in greater detail the sealed casing and the connection between the drive shaft and the driven shaft;

FIG. 6 is an enlarged sectional view of the device in FIG. 3;

FIG. 7 is a sectional view of the supporting bearing of the drive shaft extending inside the chamber according to the embodiment of FIG. 3;

FIG. 8 is a perspective view of the cradle for receiving the connection part integral with the end of the drive shaft according to the embodiment of FIGS. 3; and

FIG. 9 is a sectional view in the plane IX-IX of FIG. 3.

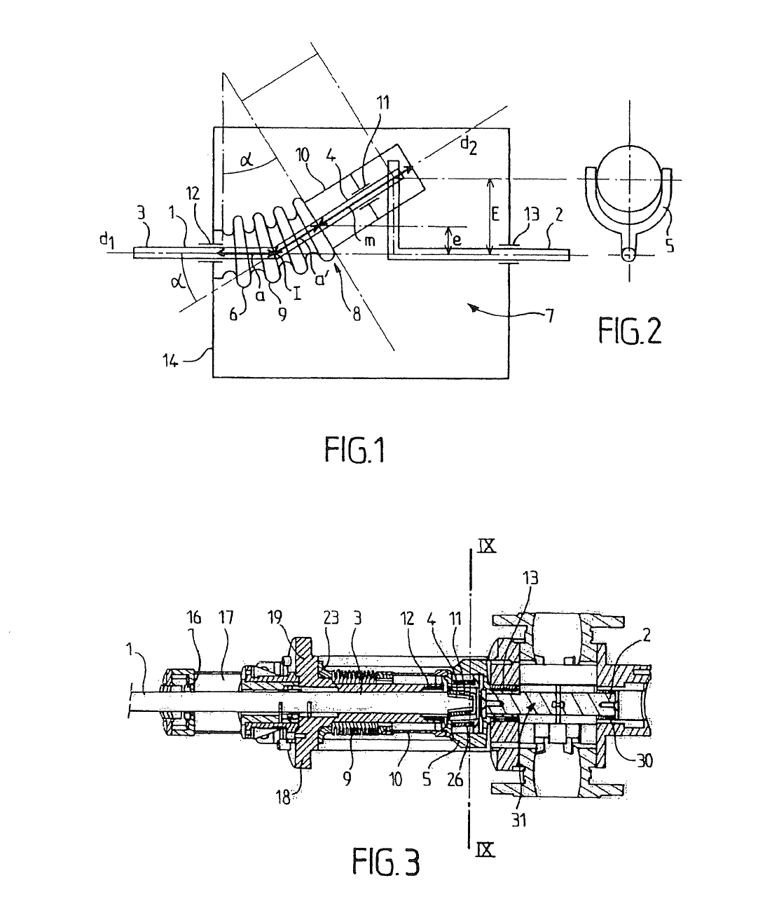

### DETAILED DESCRIPTION

FIG. 1 schematically illustrates a device for transmitting a rotational movement. The device includes a drive shaft 1, a driven shaft 2 and a non rotating chamber 7 filled with a fluid through which the transmission of the movement is carried out. The drive shaft 1 and the driven shaft 2 are mounted to rotate on the chamber through bearings 12, 13. The transmission device according to the invention is more particularly intended for a pump. Thus, the chamber 7 may particularly be a flow space of the pump through which the product goes or a sealed chamber in addition to the flow space; the driven shaft 2 may more particularly be a pump shaft on which the pumping member is mounted.

The drive shaft 1 includes an input section 3 and an output section 4, which is inclined by an angle a in relation to the input section 3. The input section 3 goes through a fixed wall 14 of the chamber 7 and cooperates with a rotation drive means positioned outside the chamber, such as a motor, not shown. The input section 3 is coaxial with the driven shaft 2. The driven shaft 2 includes a U-shaped cradle 5 making it possible to receive the off-centred end of the drive shaft 1. The eccentricity at the end of the drive shaft 1 resulting from the inclination of the output section 4 is indicated E. The effort required for the transmission of the torque to the driven shaft 2 is reversely proportional to the excentration E.

The rotation direction of the movement can be clockwise or anticlockwise. In addition, the direction of the transmission of the movement may be reverse with a drive shaft 1 becoming the driven shaft 2 and vice versa. In order to provide the sealing between the inside and the outside of the chamber 7, the part of the drive shaft 1 positioned inside the chamber 7 is surrounded by a non rotating sealed casing 8 about the axis thereof including two portions: one bellows portion 9 and one sleeve 10 extending along said bellows portion 9 towards the output section 4. The casing 8 is mounted, on the one hand, fixed in relation to the chamber 7 and on the other hand it is mounted to rotate on the output section 4 of the drive shaft 1 through a sliding bearing 11. The sliding bearing 11 may be more particularly a smooth or a ball bearing.

The bellows portion 9 makes it possible to provide flexibility to the casing 8, in the vicinity of the intersection I between the axis dl and the input section 3 and the axis d2 of the output section. In the embodiment shown, the bellows is made of a series of annular elements 6. In order to limit the constraints in such annular elements 6, the bellows 9 rotates on an arc of circle. For this purpose, the bellows 9 extends by an equal length a and a′ on either side of the intersection 1.

The sleeve 10 is rigid and makes it possible to extend the casing 8 without increasing the instability thereof. Advantageously, in order to obtain a sufficient eccentricity E, the increase in excentration brought by the portion of the output section 4 surrounded by the sleeve 10 having a length m is at least equal to the excentration e resulting from the portion of the output section 4 surrounded by the bellows 9. Thus, the length of the sleeve 10 is greater than 50% of the length of the bellows portion 9 and preferably greater than the length of the bellows portion 9.

The construction of the sealed casing 8 must provide it with a sufficient torsional rigidity to support the torsional torque which it is submitted to in operation. In one embodiment, the sealed casing 8 is made of stainless steel. Now, the construction thereof in any other material having physical and chemical characteristics suitable for such an application and more particularly ceramics can be considered.

In order to balance the pressure between the inside of the chamber 7 and the inside of the casing 8, the sealed casing 8 is filled with a liquid, preferably a lubricant. For this purpose, when the drive shaft 1 and the casing 8 are positioned inside the chamber 7, the method for manufacturing the device provides a vacuum inside the casing 8 via one or several holes, not shown. When the vacuum is provided inside the casing 8, the mounting method provides the filling of the envelope 8, via the hole or holes, with the lubricant.

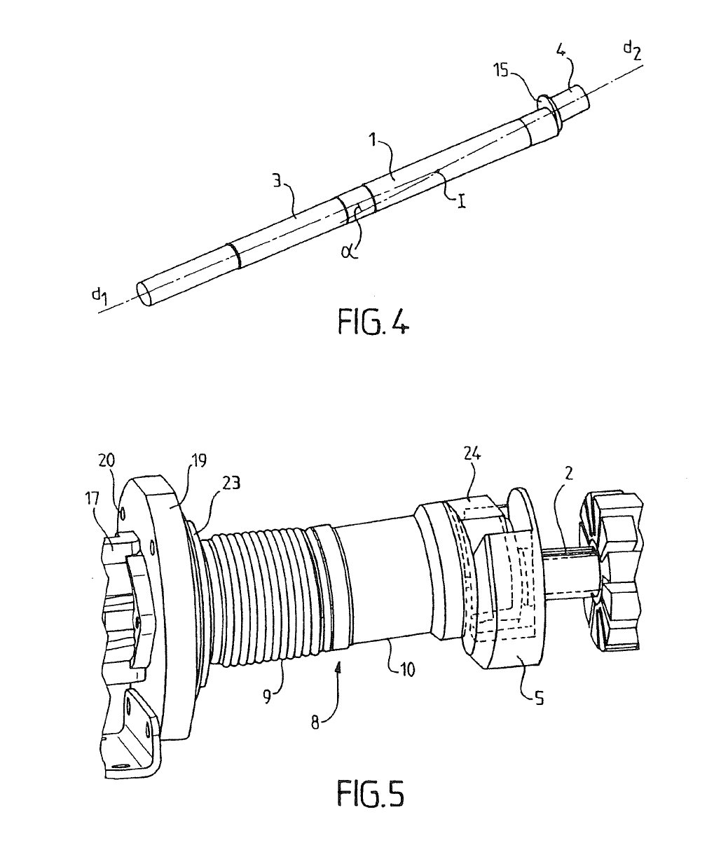

The above-mentioned FIGS. 3 to 8 illustrate a particularly embodiment of the invention. The drive shaft illustrated in FIG. 4 also has an input section 3 and an output section 4 inclined by an angle α. However, in this embodiment, the output section 4 is carried by a supporting flange 15 making it possible to laterally and angularly move said output second 4 in relation to the input section 3. Thus, the theoretical intersection 1 between the axis d1 of the input section 2 and the axis d2 of the output section 3 is located in an intermediate portion of the input section 3. The input section 3 and the output section 4 are thus so arranged as to position the lateral and angular displacement at the end of the drive shaft 1.

The drive shaft 1 is mounted on the chamber through two bearings 12, 16 (refer to FIG. 3). A first bearing 16 is carried by a bearing support 17 extending to the outside of the chamber 7 and the second bearing 12 is carried by a bearing support 18 extending inside the chamber 7. Both bearing supports 17, 18 are mounted integral with the chamber 7, not shown, in FIGS. 3 to 9. In order to reduce the force exerted on the bearings 12, 16 during the transmission of the movement, the second bearing 12 is positioned as close as possible to the point of transmission of the movement between the two shafts 1, 2. The second bearing 12 is thus positioned close to the end of the input section 3 adjacent to the output section 4. This embodiment is thus particularly advantageous since the design of the drive shaft 1 illustrated in FIG. 4 associated with a bearing support 18 extending inside the chamber 7 makes it possible to have a second bearing 12 very close to the end of the drive shaft 1.

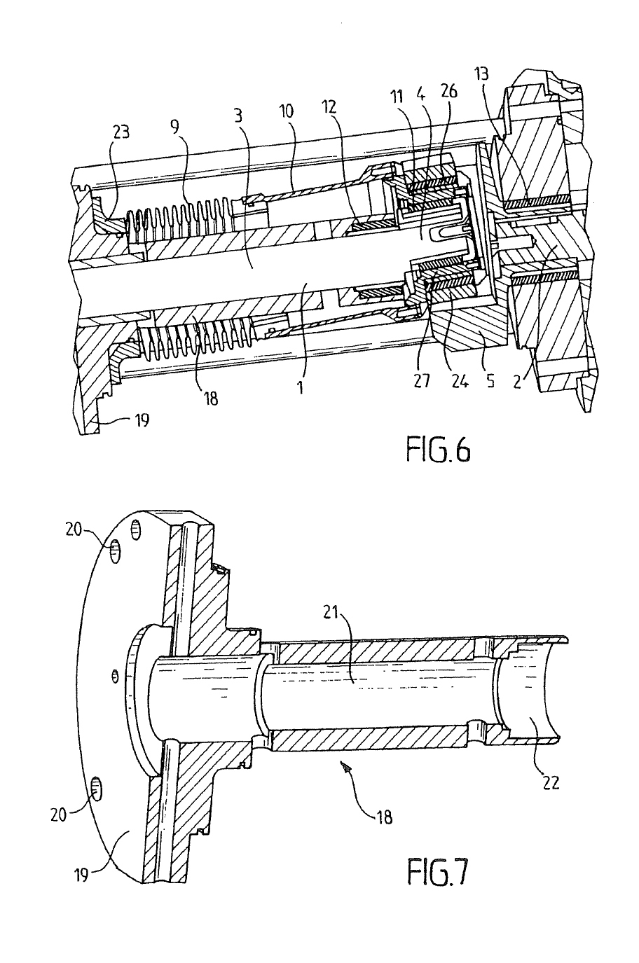

FIG. 7 illustrates in greater details said bearing support part 18. The bearing support 18 extends inside the sealed casing 8. At one end, the support 18 includes a fastening flange 19 onto the chamber 7 provided with holes 20 intended for receiving fastening members, not shown. A cylindrical bore 21 extends from the fastening flange 19 to the inside of the chamber 7 and makes it possible to let the drive shaft 1 go through. In operation, the bore 21 is also filled with lubricant. At the second end thereof, the bore 21 includes a recess 22 for receiving the second bearing 12. In addition, the sealed casing 8 illustrated in greater details in FIG. 6, is, on the one hand integral with a locking collar 23 integral with the bearing support 19 which is itself fixed to the chamber 7, and on the other hand mounted to rotate on the output section 3 of the drive shaft 1 through a sliding bearing 11.

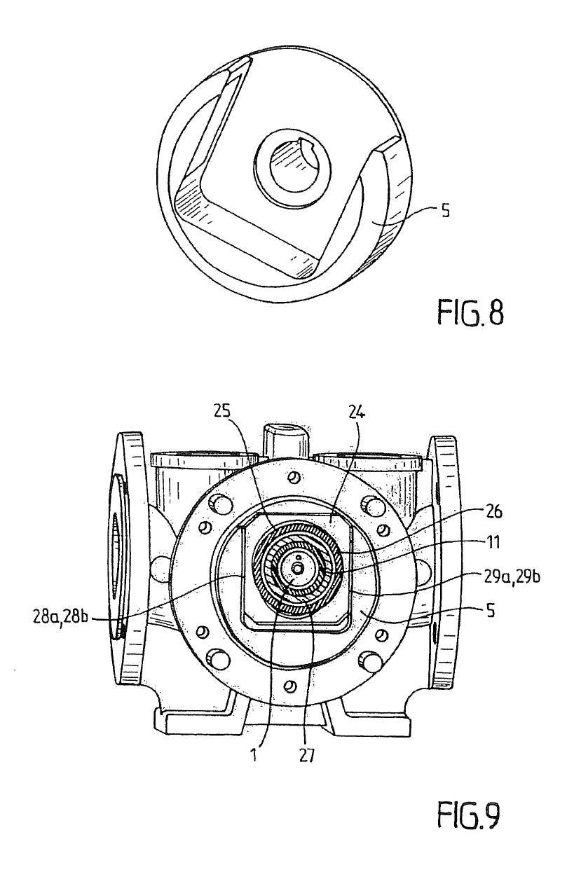

The drive shaft 1 is provided at the end thereof with a connection part 24 shown in detail in FIGS. 6 and 9. Said connection 24 is received in a U-shaped cradle 5, represented in FIGS. 8 and 9, which is integral with the end of the driven shaft 2. The connection part 24 includes a cylindrical recess 25 making it possible to receive the end of the drive shaft and the double bearing 11, 26. The sealed casing 8 is fixed to the intermediate part 27 of said double bearing 11, 26. The intermediate part 27 is mounted to slide on the drive shaft 1. Thus, as seen beforehand, the envelope 9 is mounted on the drive shaft 1 via a sliding bearing 11. The double bearing 11, 26 makes it possible for the casing 8 not to rotate whereas the connection part 24 and the drive shaft 1 are provided with a rotational movement.

The function of the cradle 5 is to transmit a movement which can be compared to the operation of a crank and is fixed to one end of the driven shaft 2. In the embodiment shown, the connection part or tip 24 and the cradle 5 have resting walls 28a, 29a, 28b, 29b which are substantially planar. However, the resting areas between the walls 28a and 28b of the connection part 24 and the walls 29a, 29b of the cradle 5 are limited to a part of the opposite areas so as to provide a play which authorises deformations in the construction or in operation without causing a locking of the movement transmission.

In the embodiment shown, said driven shaft 2 is supported by two bearings 13, 30 extending on either side of the flow space 31 of the pump (refer to FIG. 3) and includes pumping members enabling the liquid to circulate through the chamber 31. The invention is described hereabove as an example. It should be understood that the persons skilled in the art are liable to bring various modifications in the embodiment of the invention without however leaving the scope of the invention.

1. A sealed device for transmitting a rotational movement, comprising:
a chamber inside which a movement is transmitted;
a driven shaft;
a drive shaft including at least one input section extending through a wall of the chamber and intended to cooperate with a rotational driver and an output section engaged with the driven shaft and inclined by an angle α in relation to the input section; and
a non rotating sealed casing, surrounding the drive shaft inside the chamber;
the sealed casing comprising at least:
(a) bellows portion controlling flexibility on the casing at the intersection between the axis of the input section and the axis of the output section of the drive shaft; and
(b) a rigid sleeve extending alongside the bellows portion in the direction of the end of the output section of the drive shaft.

2. A sealed device for transmitting a rotational movement according to claim 1, wherein the bellows portion extends by an equal distance on either of the intersection so as to draw an arc of circle.

3. A sealed device for transmitting a rotational movement according to claim 1, wherein the length of the rigid sleeve is greater than the length of the bellows portion.

4. A sealed device for transmitting a rotational movement according to claim 1, wherein the sealed casing is filled with a liquid so as to balance the pressure between the chamber and the inside of the casing.

5. A sealed device for transmitting a rotational movement according to claim 4, wherein the liquid is a degassed lubricant.

6. A sealed device for transmitting a rotational movement according to claim 1, wherein the sealed casing is on the one hand fixed to the chamber and on the other hand mounted on the drive shaft by a sliding bearing.

7. A sealed device for transmitting a rotational movement according to claim 1, further comprising a bearing support extending inside the chamber and carrying a bearing supporting the drive shaft.

8. A sealed device for transmitting a rotational movement according to claim 7, wherein the bearing support extends inside the sealed casing.

9. A sealed device for transmitting a rotational movement according to claim 7, wherein the bearing support includes a clip for fastening onto the chamber.

10. A sealed device for transmitting a rotational movement according to claim 7, wherein the bearing extending inside the chamber is positioned close to the end of the input section adjacent to the output section.

11. A sealed device for transmitting a rotational movement according to claim 10, wherein the bearing support includes a cylindrical bore extending from the fastening clip to the inside of the chamber and enabling the passage of the drive shaft.

12. A sealed device for transmitting a rotational movement according to claim 9, wherein the sealed casing is integral with a locking collar integral with a bearing support.

13. A sealed device for transmitting a rotational movement according to claim 1, including a bearing support extending outside the chamber and carrying a bearing supporting the drive shaft.

14. A sealed device for transmitting a movement according to claim 1, wherein the output section of the drive shaft is fixed to the input section through a supporting flange in order to laterally and angularly move the output section in relation to the input section.

15. A sealed device for transmitting a movement according to claim 1, wherein the input section and the output section are so arranged as to position the lateral and angular displacement at the end of the drive shaft.

16. A sealed device for transmitting a rotational movement according to claim 1, further comprising a connection part integral with one end of the drive shaft, the driven shaft being provided with a cradle for receiving the connection part.

17. A sealed device for transmitting a rotational movement according to claim 16, wherein the connection part includes a cylindrical recess making it possible to receive the end of the drive shaft and a double bearing including an intermediate part, with the sealed casing being fixed to the intermediate part.

18. A sealed device for transmitting a rotational movement according to claim 1, wherein the sealed casing is made of a material compatible with the environmental fluids and resisting to the bending stress and the torsional stress induced.

19. A method for manufacturing a sealed transmission device according to claim 1, further comprising filling the sealed casing with a liquid so as to balance the pressure between the inside of the chamber and the inside of the casing.

20. A manufacturing method according to claim 19, further comprising a step prior to the filling step consisting in placing the sealed casing in a vacuum.
